(19) United States
(12) Patent Application Publication
(10) Pub. No.: US 2012/0296687 A1
(43) Pub. Date: Nov. 22, 2012

(54) METHOD, PROCESS AND TECHNIQUE FOR TESTING ERP SOLUTIONS

(75) Inventors: Chandrashekar Satyanarayana, Bangalore (IN); Niranjan Venkatesh Srinivasan, Bangalore (IN); Vidyadara Chidambaramurthy Arabilachi, Bangalore (IN)

(73) Assignee: Infosys Limited, Bangalore (IN)

(21) Appl. No.: 13/242,146

(22) Filed: Sep. 23, 2011

(30) Foreign Application Priority Data
May 18, 2011 (IN) 1688/CHE/2011

(51) Int. Cl. G06Q 10/06

(52) U.S. Cl. 705/7.22

(57) ABSTRACT

The present invention provides a method and system for generating testing templates suitable for the testing of ERP package based solutions. Functional test cases are prepared from real-life business processes as defined by industry standard and best practices. The test cases are reusable and can be used for any future ERP package-related projects, thereby reducing test planning effort and duration.

### BACKGROUND OF THE INVENTION

1. Technical Field of the Invention

The present invention relates to the testing of ERP solutions. More specifically, the invention facilitates the creation of reusable test templates for the testing of ERP solutions.

2. Description of the Related Art

Large organizations consistently face issues of associating their functional units with each other. The finance department of an organization should be aware of the various transactions occurring within the organization and the senior and middle management should be aware of various factors such as revenues, attrition, and new employment. Keeping these needs of an organization in mind, Enterprise Resource Planning (ERP) packages were developed.

The ERP packages evolved from manufacturing resource planning (MRP) applications. The MRP applications had originated in manufacturing industries such as automotives and heavy machines. The application was primarily concerned with the interconnection of various processes in the manufacturing industry such as job card entries and raw material procurement. The MRP evolved into MRP II after the sales cycle, purchase cycle, and accounting processes were integrated into it. The MRP II was later evolved into ERP which included manufacturing, logistics, distribution, inventory, shipping, invoicing, and accounting for a company. A significant addition to ERP was human resources. ERP was later extended to ERP II, which took the package outside the premises of one organization. Vendors/Customers could submit orders through ERP II.

SAP is one company that has pioneered the ERP package. Other companies such as Oracle, IBM, and Microsoft also provide its own ERP packages. Most of the ERP packages available in the market today have adopted a three-layer architecture consisting of a front end (aka client end), an application server (aka middle layer), and a database (aka back end).

The ERP package has a unique project lifecycle involving many phases—implementation, rollout, maintenance (application of patches and development of enhancements), and upgrade. Implementation refers to the stage wherein the needs of the organization are understood, and the software package is accordingly modified to meet those requirements. Once the software has been implemented, it can be extended to various functional or geographical units within the organization. This process is referred to as “package rollout”. The ERP package vendors continue making modifications/upgrades to the main package. Vendors typically release “patches,” which are applied by a support and maintenance team for the package. The patches help keep the ERP package up to date and may affect only one or two layers of the package. Minor changes in the ERP package are required to keep pace with business changes. These changes are called “enhancements” and are developed by the support and maintenance team. Generally, the enhancements affect only one or two layers of the ERP package. However, major changes to the ERP package are applied by a process known as “package upgrade”. Typically, an upgrade affects all the layers of ERP software package.

Given the current dynamic nature of most organizations, an ERP software package will keep on undergoing one change or the other throughout its lifecycle, as described earlier. This requirement makes testing of the ERP software package significantly critical at every stage. Improper testing during the implementation phase can lead to bugs in the ERP package-based solutions that are made available to the end users, and thus can increase the risk to businesses supported by the ERP package-based solution. The support and maintenance overhead also increases substantially if proper testing is not conducted at other lifecycle stages of the software package.

Traditionally, the team that implements the ERP software package is also responsible for the testing of the package. However, the concept of an independent testing team has also sprung up in most organizations recently. Since the independent testing team is not typically involved in defining the ERP package-based solutions during the implementation phase, it faces various issues during its entire lifecycle, wherein it has to coordinate with other teams for the purpose of knowledge transfer and also to ensure that it gives correct certification for any changes (made by teams for other stages like implementation or upgrade or support & maintenance) which it tests. Another main challenge that an independent testing team faces is the short turn-around time. They have to complete the process of knowledge transfer and testing within a short period of time, which makes it all the more difficult for them to carry out adequate testing of big ERP software packages such as SAP and Oracle.

To address these and other problems that an independent testing team faces, various solutions such as prepackaged testing solutions and reusable test cases have been developed. These practices help the testing team reduce the time and effort. However, the existing solutions do not adopt a holistic approach and rather provide a piecemeal solution to the existing problems.

Therefore, a holistic testing solution for ERP packages is required. The solution is expected to reduce the turn-around time for testing project and also provide a more comprehensive set of testing tools which will make the testing process more efficient and accurate.

### BRIEF DESCRIPTION

The current invention provides a method and system for preparing reusable testing templates suitable for ERP packages.

It is an objective of the present invention to generate a plurality of business workflows and test scenarios based on predefined business practices.

It is another objective of the invention to generate a plurality of functional test cases based on the plurality of business workflows and test scenarios.

It is yet another objective of the invention to develop a plurality of reusable master business process components based on the plurality of the functional test cases

It is still another objective of the invention to automate the plurality of functional test cases based on the plurality of the reusable master business components.

Another objective of the current invention is to generate a plurality of reusable testing templates based on the plurality of automated test scripts.

Another objective of the current invention is to reduce the time and/or effort and/or cost required for knowledge transfer from the implementation, rollout, upgrade, or support and maintenance team to the independent testing team.

Another objective of the current invention is to provide a holistic solution which addresses both functional testing and test automation challenges.

Another objective of the current invention is to facilitate the creation of a repository of reusable functional test cases which can be reused for any future ERP package-related projects.

Yet another objective of the current invention is to provide an end-to-end methodology for the development of automated test scripts from business practices.

Still another objective of the current invention is to facilitate the creation of reusable test cases and/or test scenarios based on industry standard and best business practices.

### DRAWINGS

The accompanying figures, where like reference numerals refer to identical or functionally similar elements throughout the separate views, and which, together with the detailed description below, are incorporated in and form part of the specification, serve to further illustrate various embodiments, and explain various principles and advantages, all in accordance with the present invention.

FIG. 1 illustrates an environment wherein the current invention can be practiced, in accordance with various embodiments of the present invention;

FIG. 2 illustrates the various stages of developing automated test scripts for an ERP package by an independent testing team;

FIG. 3 is a flowchart depicting the process of creating reusable functional test cases;

FIGS. 4-7 illustrate snapshots depicting the stepwise process of business workflow generation;

FIG. 8 illustrates a screenshot of the process of invoking the functional test case generation feature of a workflow modeling tool; and

FIGS. 9-11 illustrate the process of the development of the test automation components.

Skilled artisans will appreciate that elements in the figures are illustrated for simplicity and clarity and have not necessarily been drawn to scale. For example, the dimensions of some of the elements in the figures may be exaggerated, relative to other elements, to help improve an understanding of the embodiments of the present invention.

### DETAILED DESCRIPTION

A method for generating reusable, functional test cases, and automated test scripts for testing ERP packages is provided. The method provides an independent testing team with a holistic testing solution to perform ERP package testing from the implementation phase to the support and maintenance phase. The invention can be extended to all the lifecycle stages of an ERP package, and it will also take future projects into consideration.

The testing solution developed in the present invention provides a scalable and robust model that can be upgraded to meet the requirements of various current and future versions of ERP packages available in the market. The current solution has been developed in accordance with SAP best practices.

The implementation and various embodiments of the present invention have been explained below in detail with the help of various diagrams and illustrations.

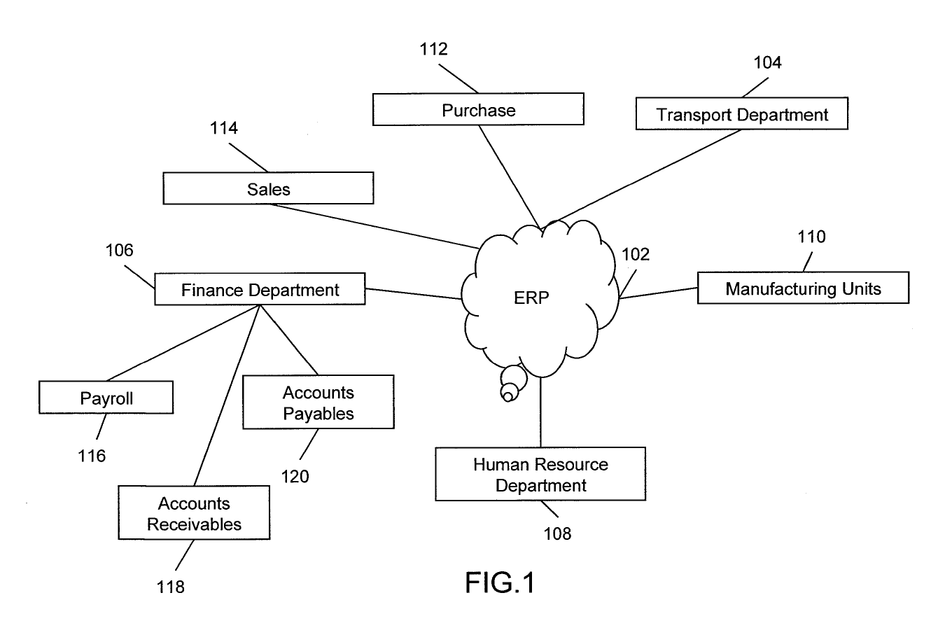

FIG. 1 illustrates an environment wherein the present invention can be implemented in accordance with the present invention. FIG. 1 represents the ERP package implementation in an organization with various operational units such as manufacturing lines, human resources management, finance, sales, purchase, and transport. The finance department can further be divided into other sub-functional units such as payroll, accounts receivables and accounts payables. The ERP package is responsible for collating all the important information from these operational units and for providing a platform for interconnectivity of these units so that key performance indicators regarding the operational efficiency of the organization can be generated. For example, the ERP package will provide the employees of an organization with a common platform to log their daily activities, the purchase department team to place raw materials order and so on. Using the daily activities data entered by the employees, the HR management team can track work load across the operational units to decide upon new hiring processes and so on. Similarly, based on the purchase orders entered by the purchase team, the finance management team can plan for the cash flow required for the month. In effect, the ERP package can generate useful results based on the data entered by employees, to help drive the day-to-day and periodic activities of the organization.

The ERP testing solution will be developed and implemented in accordance with the various operating units and sub-functions explained in FIG. 1.

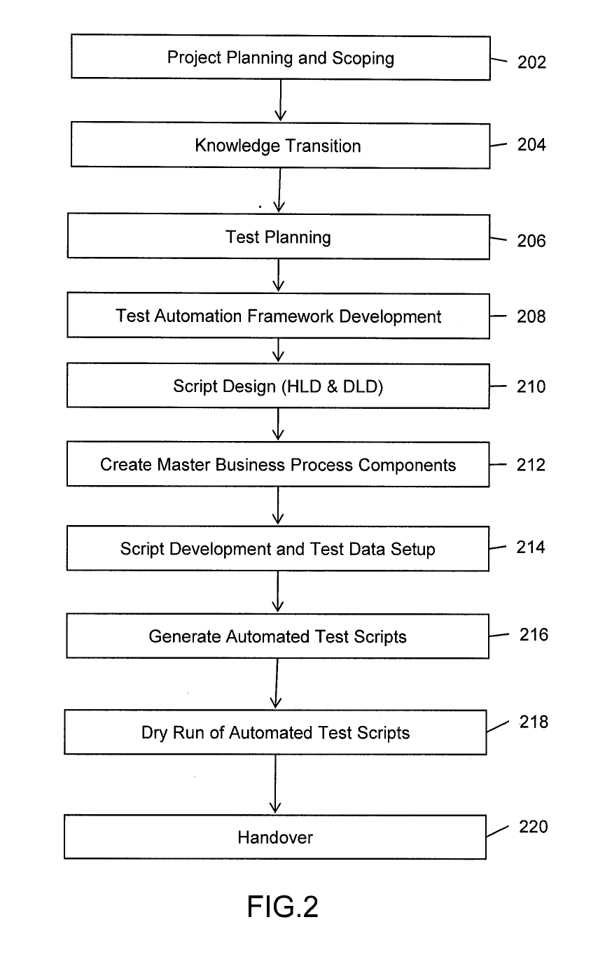

FIG. 2 illustrates the various stages of developing automated test scripts for an ERP package by an independent testing team. As depicted in the diagram, 202 represents the stage where the package implementation team gathers an organization's requirements and accordingly customizes the ERP package. During the same stage, the independent testing team would review these requirements for testability and comprehensiveness. 204 represents the knowledge transition phase, wherein the implementation team will transfer all relevant information pertaining to the ERP software package being implemented to the independent testing team. A POSITA will appreciate that typically the knowledge transition phase is fairly time consuming and at times acts as a hindrance to the, pressed for time, independent testing team.

206 represents the “test planning” phase wherein the independent testing team formulates the key testing requirements and prepare the functional test cases based on the knowledge passed on from the implementation team in step 204. 208 represents the “test automation framework development” phase wherein a test automation framework as appropriate for the testing requirements identified in step 202 and the functional test cases prepared in step 206 are developed. For a large scale software like the ERP package, the independent testing team usually gets 2-3 months to develop automated test scripts, test the same, and make it available for the system integration testing team. This pressurizes the independent testing team enormously. Currently, the independent testing team cannot initiate the process of test automation until the package implementation team designs an environment, which is put in place, has all the requirements and constraints, under which the final ERP package will operate. The current invention makes use of a test accelerator to generate some parts of the automated test scripts at the time when the implementation team begins to work on implementing the ERP package.

At 210, test script design takes place wherein the independent testing team prepares the outline for the test scripts. The independent testing team prepares high level designs (HLD) and detailed level designs (DLD) for preparing the automated test scripts. The HLD comprises details of all test scenarios of a particular business process. The DLD is prepared for every SAP transaction code (T-Code) and contains all fields and screens within the T-Code. The independent testing team will also review the HLDs and the DLDs at 210. A particular DLD will be unique for a particular T-Code and would provide the details of the corresponding Master Business Process Component that needs to be developed. A detailed discussion on the preparation of HLDs, DLDs, and test automation components has been provided later in this section of the document.

At 212 various reusable Master Business Process Components (MBPCs) are developed in the test accelerator based on the DLDs prepared in step 210. At step 214, the test scripts corresponding to various test scenarios depicted in HLDs are developed in the test accelerator. The test data associated with these test scripts is also setup using appropriate functionality of the test accelerator.

The automated test scripts for testing the ERP package being implemented are generated at 216. The test accelerator helps in the development of reusable automated test scripts at the beginning of the ERP package project by the independent testing team. This effectively helps in quicker turn around. For example, using the current invention, the testing team can develop many parts of a testing script by the time the implementation team develops the testing environment for the ERP package. All test cases generated using the test accelerator are stored in a repository so that they can be reused for future requirements.

218 represents the dry-run phase, where the testing team tests the generated scripts for accuracy. 220 represents the handover phase where the testing team transfers the scripts to the testing team of the ERP package.

The steps discussed above are meant to provide an overview of the development of automated test scripts.

As mentioned in the description of step 216, the reusable test cases are formulated using SAP best practices; therefore, they can be extended to new versions of SAP ERP in the future. The SAP best practices are a collection of standardized business practices for various functions in any organization. For example, in a manufacturing company there is a separate department responsible for purchases. The department operates on certain practices such as who is responsible for purchases, who is the authorized signatory, and what is the maximum order value. The best practices around all these functions are consolidated according to every functional unit and included in the SAP best practices. SAP best practices are referred herein as exemplary. However, it will be evident to a POSITA that any set of industry standard and best practices can be used to develop the test scripts for test automation purposes and that the reference to SAP best practices herein in no way limit the scope of the invention. The current invention utilizes a workflow modeling tool to create business workflows and test scenarios from the SAP best practices. The workflow modeling tool helps in the creation of detailed level business workflows and test scenarios that can be used by the independent testing team to generate reusable functional test cases and automated test scripts. Another tool integrated within the workflow modeling tool is the test case generator, which enables an independent testing team to automatically generate relevant functional test cases from the business workflows and task flows created using workflow modeling tool. In an embodiment of the invention, any tool developed by other companies such as IBM can be used for generating workflows and functional test cases.

The detailed discussion on the development of the functional test cases and their automation will be discussed in detail below.

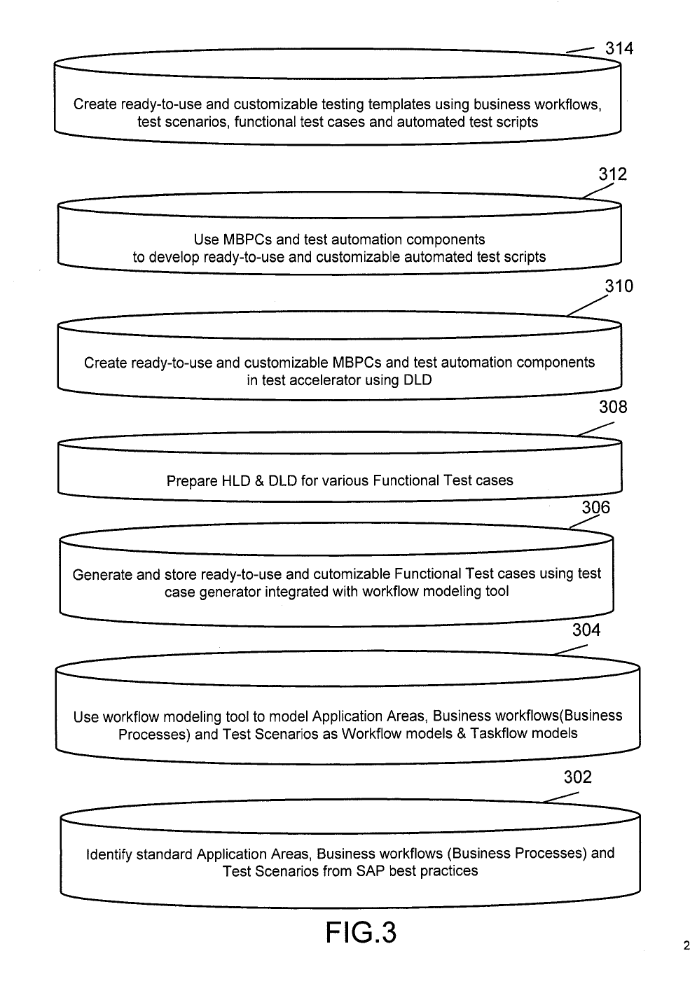

FIG. 3 is a flowchart depicting the process of creating reusable functional test cases, as per an embodiment of the present invention.

At step 302, application areas, business workflows (also known as business processes) and test scenarios are identified from the SAP best practices. The business workflows are a representation of all the typical day-to-day and periodic business processes involved in any business unit of an organization. For example, in the finance department of an organization, the standard business workflow will represent processes for various functions such as accounts receivables, accounts payables, and payroll. The application areas, business workflows, and test scenarios extracted from SAP best practices are entered into the workflow modeling tool at 304 as workflow models and task flow models.

At step 304, the workflow modeling tool is used to model application areas, business workflows (business processes), and test scenarios as workflow models and task flow models. The workflow models and task flow models are reusable and can be used by the testing team for future upgrades or other similar projects. In an embodiment of the invention, any collection of industry standard and best practices can be used to generate various testing templates.\

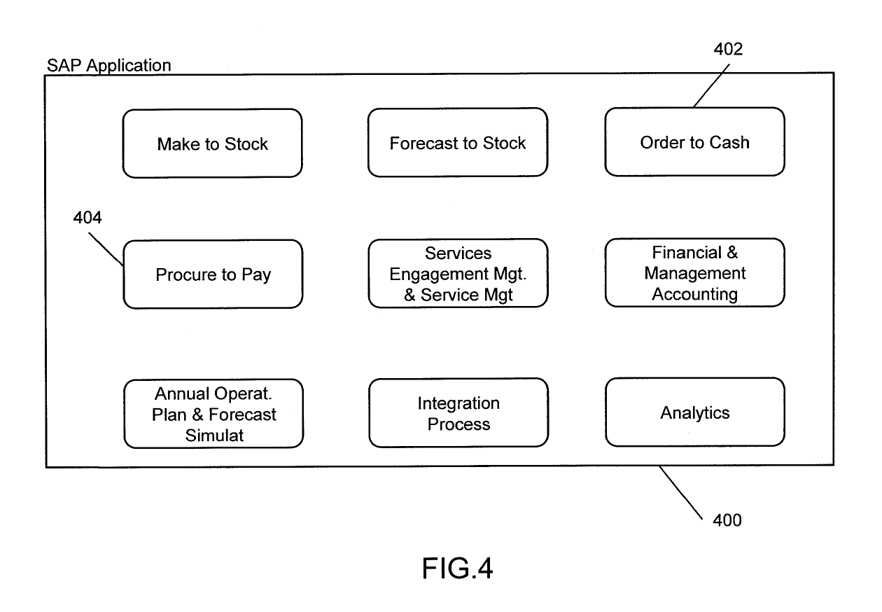

A workflow model provides a high-level representation of the business process. The underlying task flow model provides the detailed view of the test steps involved in the execution of the relevant SAP T-Code and the corresponding screen details. Snapshots of the process of creation of business workflows have been provided in FIGS. 4-7, and these will be used to explain the process in detail.

FIG. 4 represents the first step of the creation of a testing template. As shown in snapshot 400, SAP best practices are grouped under application areas. These application areas are the building blocks of the testing templates and are accordingly designated as zeroth-level workflow model in the workflow modeling tool. As can be seen in FIG. 4, two application areas are designated as “order-to-cash”*(402) and “procure-to-pay” (404). These application areas will be used for the preparation of business workflows (business processes) as the next level of workflow models in workflow modeling tool. 402 and 404 have been used as examples to illustrate the processes involved in the current invention. It will be understood to a POSITA that the current invention, in its present form, can also be used in various other application areas.

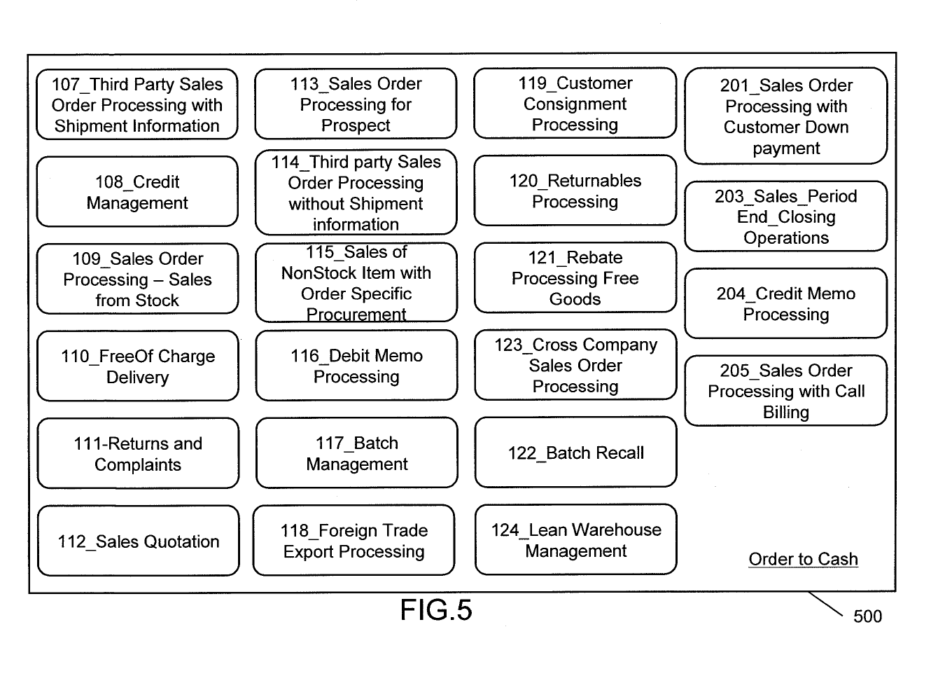

FIG. 5 represents the second step in the creation of the testing template. The snapshot depicts a first-level workflow model. 402 and 404, as discussed in the description of FIG. 5, will have associated business workflows (business processes). The various business workflows (business processes) depicted in the snapshot are in accordance with the application areas 402 and 404. These business workflows (business processes) form the first-level of the testing template as per an embodiment of the invention.

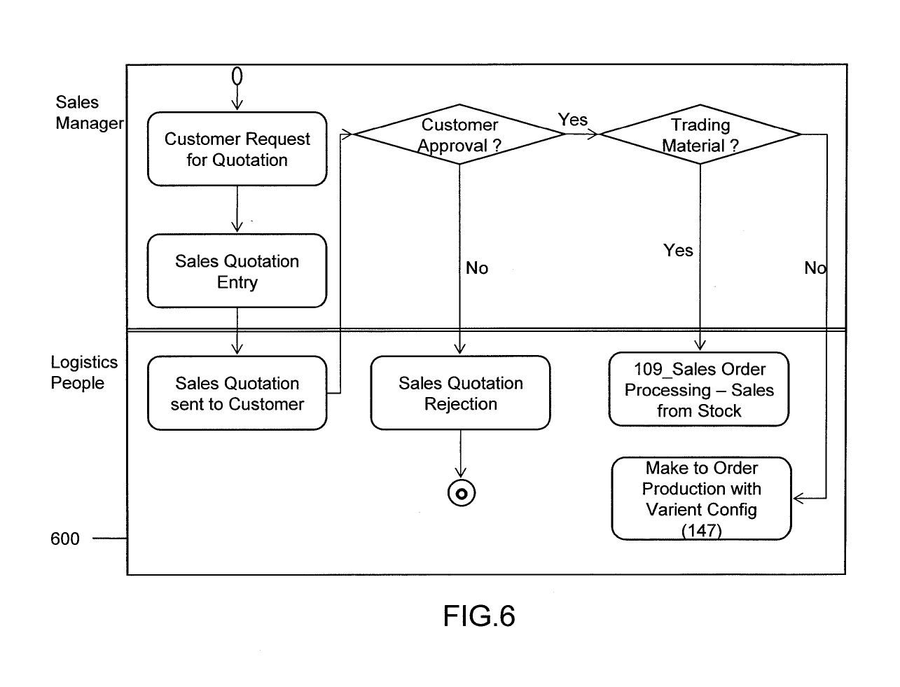

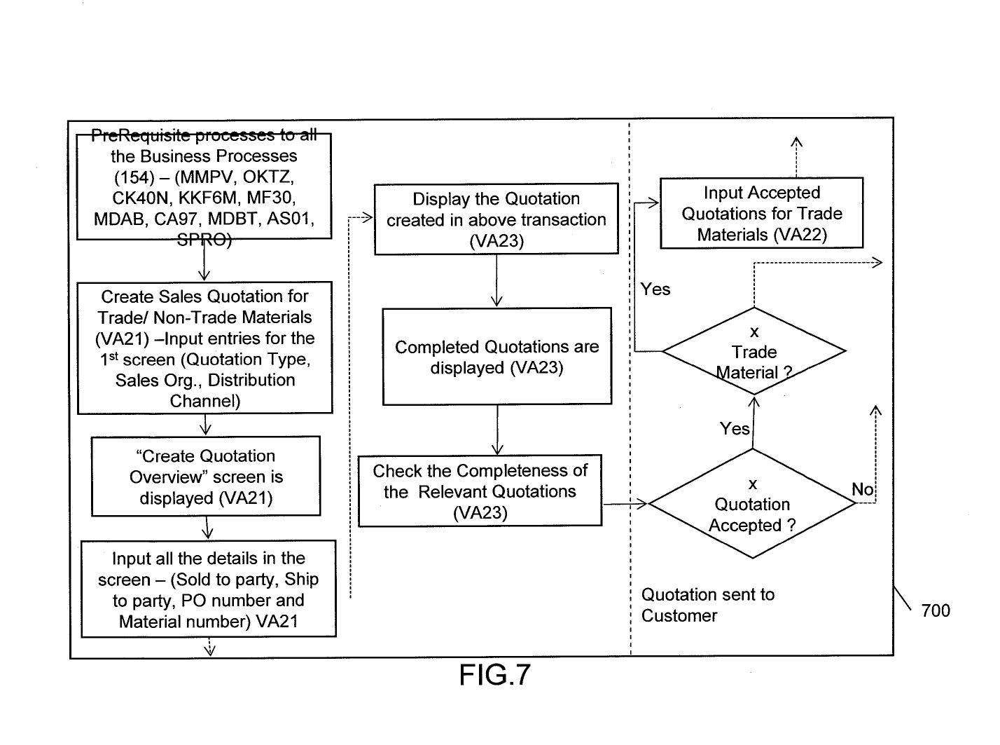

FIG. 6 represents the third step in the generation of testing template, using the workflow modeling tool. Since ERP typically forms a common platform for all the functional units of an organization, it is reasonable that each business workflow (business process), as discussed in the step two, will give rise to multiple test scenarios. All the test scenarios corresponding to each of the business workflow (business process) are depicted as the second-level workflow model in the workflow modeling tool. FIG. 6 depicts the snapshot 600 of all the possible test scenarios for a business workflow (business process). The second-level workflow model for the individual business workflows (business processes) are used to create the corresponding taskflow model in the workflow modeling tool. The taskflow model affords enough flexibility to incorporate all possible test scenarios of a business workflow (business process). The taskflow model also affords enough granularity to incorporate all the test steps, the corresponding SAP T-Code, the associated test data, and the expected result. A sample taskflow model for a particular business workflow (business process) is depicted in the snapshot provided in FIG. 7. The boxes depicted in grey color represent the input by a user (commonly called as test step), and the white boxes represent the output generated by the system (commonly called as expected result). To illustrate the process in detail, FIG. 7 represents a sales quotation business process for trade and non-trade materials in an organization. A user from the testing team can manually input certain parameters for the sales quotation in the appropriate SAP T-Code as indicated in the grey boxes in FIG. 7, and the system is expected to generate a suitable response for each or a set of inputs. The response is represented by the white boxes in FIG. 7.

The current invention is scalable, in accordance with the embodiments discussed, and all the processes discussed above can be reused for other application areas and the corresponding business workflows (business processes) simply by changing the corresponding SAP best practices. As per the present embodiment of the invention, the workflow models and taskflow models created at 304 are ready-to-use at this stage and can be used by the independent testing team for initiating testing processes. The workflow models and taskflow models are also customizable so that they can be modified according to any new requirements put forth by the implementation team.

The workflow models and taskflow models thus generated at 304 are used for the generation of functional test cases as described at 306.

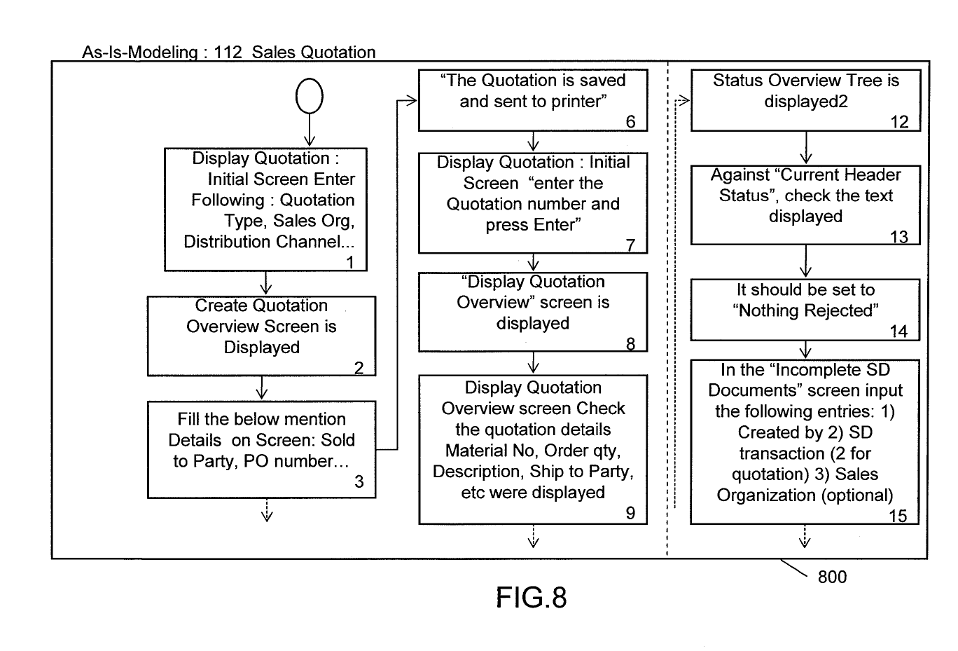

At 306, the functional test cases are generated from the plurality of the taskflow models using the test case generator integrated with the workflow modeling tool, and are stored in a functional test case repository. A screenshot of the process of invoking the functional test case generation feature of the workflow modeling tool using the integrated test case generator has been provided in FIG. 8. All the business processes and application areas discussed above pertain to “order-to-cash” 402 and “procure-to-pay” 404 business workflow (business process) in an organization. The current invention is scalable, in accordance with the embodiments discussed, and all the processes discussed above can be reused for other application areas and the corresponding business workflows (business processes) simply by changing the corresponding SAP best practices. As per the present embodiment of the invention, the functional test cases generated at 306 are ready-to-use at this stage and can be used by the independent testing team for initiating testing processes. The functional test cases are customizable so that they can be modified according to any new requirements put forth by the implementation team.

Once all the functional test cases have been developed, they are stored in a repository for future purposes. The test automation components are developed at 308.

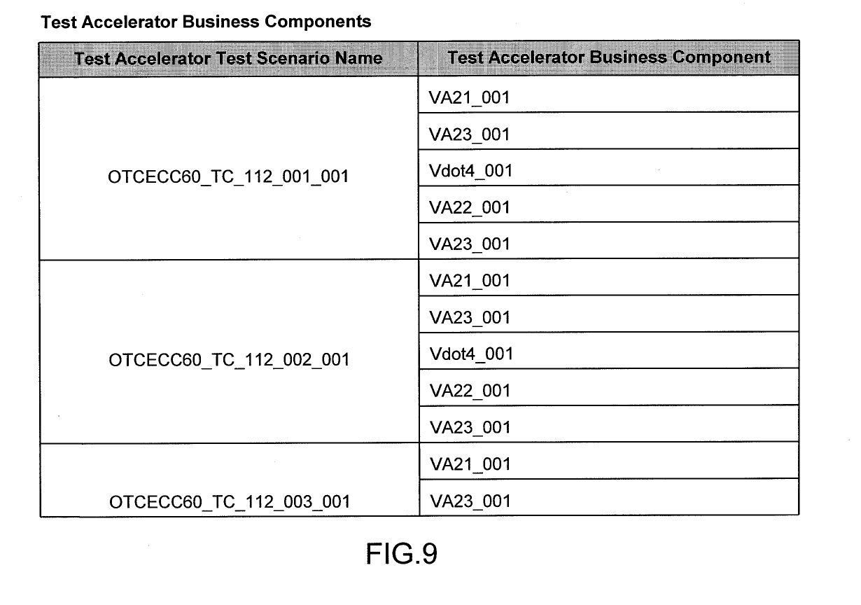

At 308, high-level design documents (HLDs) and detail design documents (DLDs) are prepared for the various functional test cases generated at step 306. The design of the automated test scripts is a two-step process, and it initiates with the development of HLDs. A HLD is prepared for each business workflow (business process) as represented by the second-level workflow model in the description of FIG. 6. The HLD document will contain details of all test scenarios of that particular business workflow (business process) based on the corresponding functional test cases generated at 306 and their mapping with the respective MBPCs FIG. 9 represents a snapshot of an HLD document. As shown in FIG. 9, the HLD contains all the MBPCs that need to be developed for a test scenario in the test accelerator.

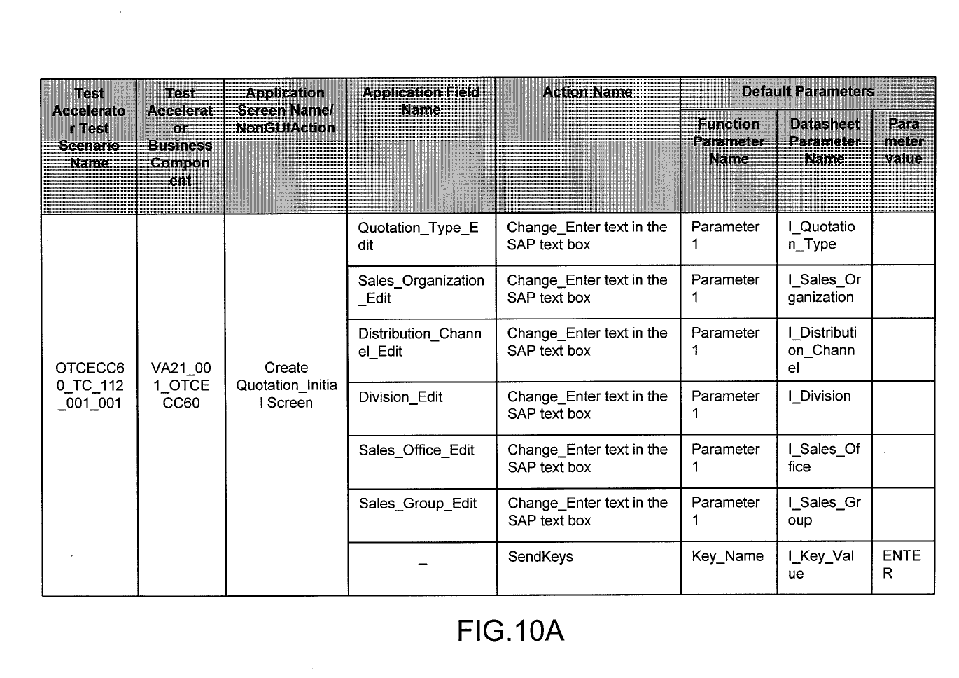

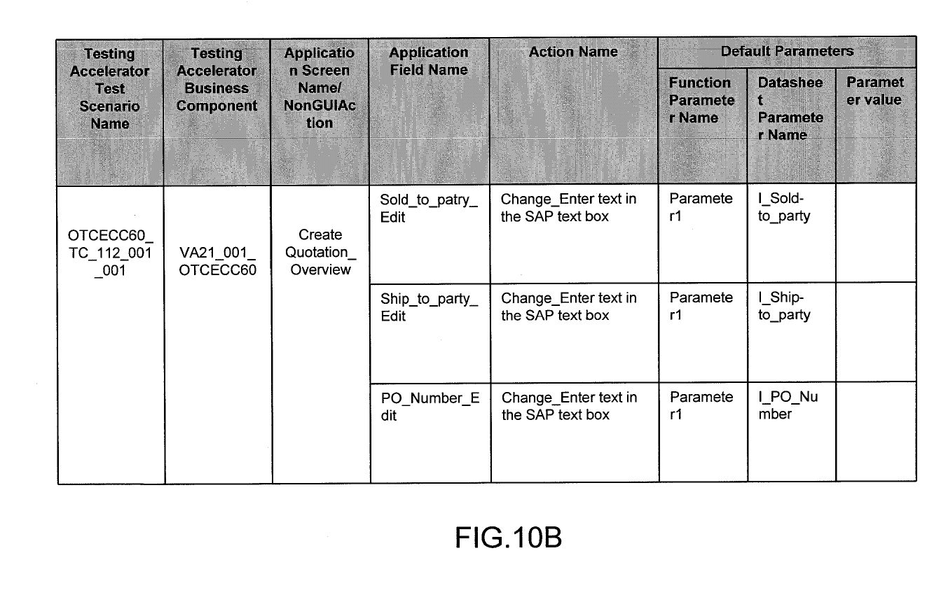

The second step in the design of the automated test scripts involves the preparation of the DLD. As discussed earlier, a DLD is prepared for each individual T-Code within SAP, and it contains details of all SAP screens, SAP fields, test accelerator controls, and test accelerator functions associated with the individual T-Code and mapping of the same with respective test scenarios (functional test cases generated from the test case generator and documented in the test case repository). A sample DLD document is provided as in FIGS. 10A and 10B. FIGS. 10A and 10B list all the business components that need to be associated with the respective test accelerator test scenarios for automating various test cases. As can be seen from the snapshots, the DLD lists all business components that need to be associated with the respective test scenarios.

At 310, ready-to-use and customizable MBPCs are developed for each T-Code. MBPCs are created using the test accelerator. MBPCs are the building blocks of the automated test scripts and are developed for an individual SAP T-Code. As discussed earlier, every business process within SAP is made up of many T-Codes. Within a particular business process, there can be process variants, which can vary in number based on the diversity of the business environment. Traditionally, a separate business process component (BPC) needs to be developed for every T-Code corresponding to each business process variant which led to a lot of wastage of time in test automation and maintenance. The test automation process of the current invention employs the test accelerator and develops one MBPC per T-Code, thereby greatly reducing the effort spent in test automation and subsequent maintenance. All business process variants are included within the MBPC itself, which saves the independent testing team from preparing new business process components per T-Code for every business process variant by using an appropriate feature of the test accelerator. Further, in the present embodiment of the invention, the test accelerator provides features to make modifications to an existing MBPC according to the corresponding changes in the business processes. The process of the development of an MBPC will be explained in detail in conjunction with accompanying FIGS. 9-11.

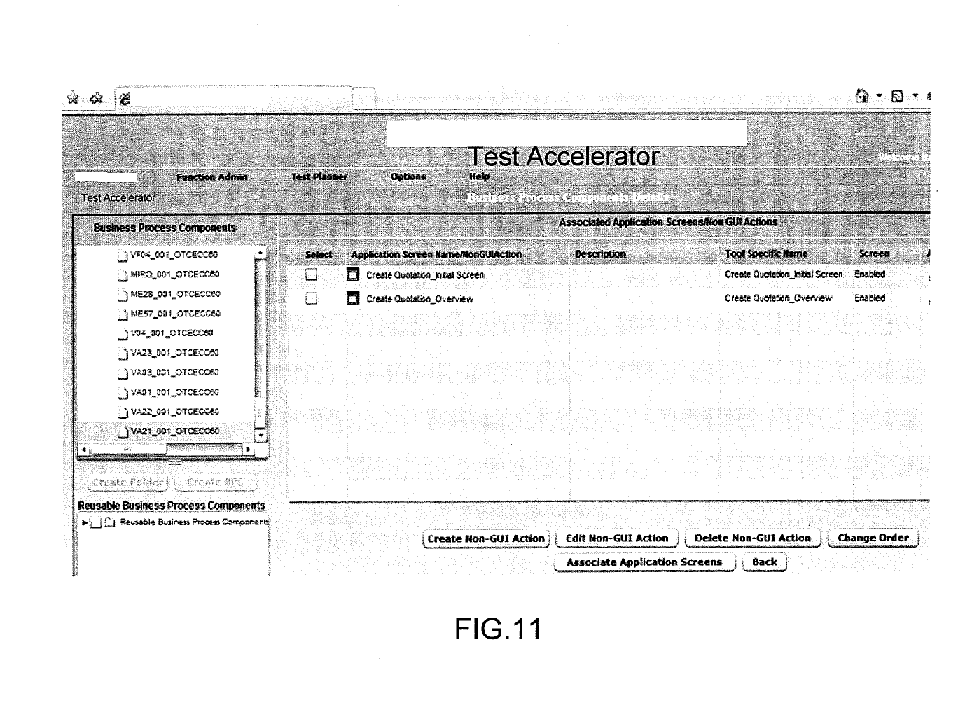

The development of an MBPC is based on the corresponding DLD for the same T-Code. The development of an MBPC is the first step in the process of developing the automated test scripts using the test accelerator. A screenshot of a sample MBPC is provided in FIG. 11. Once all the MBPCs are developed, the test automation components and MBPCs are used to develop ready-to-use and customizable automated test scripts at 312 (as discussed in the description of FIGS. 10A, 10B and 11). Various test scenarios as depicted in the HLD document for each of the business scenario are modeled using the respective MBPCs specified in the HLD document.

Once the automated test scripts are developed using MBPCs, the reusable testing templates are created and stored in a repository at 314. The ready-to-use and customizable testing templates are generated by using business workflows, test scenarios, functional test cases, and automated test scripts.

To aid the process of assisting the ERP rollouts for future requirements, a generic traceability matrix is created, and subsequently maintained to record the creation and maintenance of business workflows, test scenarios, functional test cases, MBPCs, and automated test scripts.

It will be understood to a person ordinarily skilled in the art that references made to proprietary tools and software are only exemplary, and any other suitable tool or software can be used for implementing the current invention without deviating from the spirit of the invention.

Further, the reference to SAP in the description of the current invention is only for exemplary purposes. Any suitable ERP package can benefit from the use of the current invention. For example, the current invention can also be implemented for the testing of ERP solutions marketed by companies such as Oracle, IBM, and Microsoft. Further, the SAP best practices, as referred herein, are only for exemplary purposes and any set of standard business practices can be used for developing business workflows in accordance with various embodiments of the present invention.

### ADVANTAGES

The current invention provides various advantages over existing methods and technologies. Some of these advantages are

The current invention reduces the time and effort required for knowledge transfer from the ERP package implementation or upgrade, rollout, and support and Maintenance team to the independent testing team.

The current invention delivers a holistic solution that addresses both functional and test automation challenges.

The current invention facilitates the creation of a repository of reusable functional test cases that can also be reused during any future ERP package-related projects.

The current invention provides an end-to-end methodology for the development of automated test scripts from business practices.

The current invention facilitates the creation of reusable test cases and/or test scenarios based on industry standard and best business practices.

In the foregoing specification, the invention and its benefits and advantages have been described with reference to specific embodiments. However, one with ordinary skills in the art would appreciate that various modifications can be made, without departing from the scope of the present invention, as set forth in the claims below. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required or essential features, or elements of any or all the claims. The invention is defined solely by the appended claims, including any amendments made during the pendency of this application and all equivalents of those claims, as issued.

We claim:

1. A method for preparing reusable testing templates suitable for use on ERP solutions, the method comprising:
a. generating a plurality of business workflows and test scenarios based on predefined business practices;
b. generating a plurality of functional test cases on the basis of the plurality of business workflows and test scenarios;
c. developing a plurality of reusable master business process components based on the plurality of functional test cases;
d. automating the plurality of functional test cases on the basis of the plurality of reusable master business process components; and
e. generating a plurality of reusable testing templates on the basis of the plurality of automated test scripts.

2. The method of claim 1, wherein the predefined business practices is a collection of all possible business workflows (business processes) and test scenarios within an organization.

3. The method of claim 1, wherein each one of the plurality of functional test cases is generated for each one of the plurality of business workflows (business processes) and test scenarios.

4. The method of claim 1 further comprising maintaining a repository of the plurality of functional test cases.

5. The method of claim 1 further comprising creating and maintaining a test case traceablility matrix to record creation and maintenance of the plurality of business workflows (business processes) and test scenarios.

6. The method of claim 5 further comprising recording the creation and maintenance of the plurality of functional test cases in the test case traceablility matrix.

7. The method of claim 5 further comprising recording the development and maintenance of the master business process components in the test case traceablility matrix.

8. The method of claim 5 further comprising recording the development and maintenance of the automated test scripts in the test case traceablility matrix.

9. The method of claim 5, wherein each of the plurality of functional test cases comprises a plurality of SAP transaction codes.

10. The method of claim 1, wherein automating the plurality of functional test cases comprises preparing a high level design and a detailed level design.

11. The method of claim 6, wherein the high level design is prepared for each one of the plurality of the plurality of the business workflows.

12. The method of claim 10, wherein the detailed level design is prepared for each one of a plurality of the SAP transaction codes associated with each one of the plurality of functional test cases.

13. A system for preparing reusable testing templates suitable for use on ERP solutions, the system comprising:
a. a first processor for generating a plurality of business workflows and test scenarios based on predefined business practices;
b. a second processor for generating a plurality of functional test cases on the basis of the plurality of business workflows and test scenarios; and
c. a third processor for developing a plurality of reusable master business process components;
d. an automation engine for automating the plurality of functional test cases on the basis of the plurality of reusable master business process components; and
e. a fourth processor for generating a plurality of reusable testing templates on the basis of the plurality of automated functional test cases.

14. The system of claim 13, wherein the second processor is further configured to create a repository of the plurality of functional test cases.

15. The system of claim 13, wherein the automation engine is further configured to generate automated test scripts that can be run using industry standard test automation tools.
